(19) United States
(12) Patent Application Publication
(10) Pub. No.: US 2008/0201769 A1
(43) Pub. Date: Aug. 21, 2008

(54) SYSTEM AND METHOD FOR PROCESSING PAYMENT OPTIONS

(76) Inventor: Peter George Finn, Brampton (CA)

Correspondence Address: IBM CORPORATION, IPLAW SHCB/40-3, 1701 NORTH STREET, ENDICOTT, NY, 13760, US

(21) Appl. No.: 12/029,489

(22) Filed: Feb. 12, 2008

(30) Foreign Application Priority Data
Feb. 15, 2007 (CA) 2578893

(51) Int. Cl. G06F 17/30; H04L 9/32

(52) U.S. Cl. 726/7; 707/104.1; 707/10; 707/E17.044

(57) ABSTRACT

Disclosed is a system and method for processing payment options, including consolidation, selection, and secure identification. In one embodiment, multiple payment options such as credit, debit and loyalty cards are registered by a consumer and consolidated into a secure central repository. The consumer securely accesses the central repository over a secure communications channel from a remote access device, such as a point-of sale (POS) terminal at a merchant store, to retrieve and select from one of the available payment methods. Upon selection, additional data sufficient to complete the payment transaction is sent to the POS terminal. The consumer may use a piece of identification and password (e.g., one of the registered cards together with a password or personal identification number) to securely access the multiple payment options. Alternatively, the consumer is identified by using a biometric identifier, such as a fingerprint or retina scanner, without need for additional identification.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### RELATED APPLICATIONS

This application claims foreign priority benefits under Title 35, United States Code, Section 119 of Canadian Patent Application No. 2578893, filed Feb. 15, 2007, the contents of which are hereby incorporated by reference.

### FIELD OF THE INVENTION

The present invention relates to systems and methods for processing payment options, including consolidation, selection, and secure identification.

### BACKGROUND OF THE INVENTION

With the proliferation of payment methods, today's consumers may carry multiple credit cards, debit cards, loyalty cards, club membership cards and numerous forms of identification cards. In some cases, a consumer may have so many cards that it becomes cumbersome or impossible to carry all of them in a wallet. The consumer may then resort to carrying only those cards used most often, or to swap out cards as needed on a particular day. Additionally, a consumer with so many cards is at increased risk of identity theft or misuse of these cards if a wallet or purse is lost or stolen.

Examples of existing technical solutions are listed hereinbelow. Maritzen et al., in U.S. Patent Application No. 2002/0128878 describes a method and apparatus for consolidating billing information and paying suppliers on a network. Crooks et al., in U.S. Pat. No. 6,052,671 describes computerized bill consolidation, billing and payment authorization with remote access to the billing information. Embrey, in U.S. Pat. No. 6,311,170 describes a method and apparatus for making payments and delivering payment information. O'Leary et al., in U.S. Pat. No. 6,609,113 describes a method and system for processing internet payments using the electronic funds transfer network. Gross, in U.S. Pat. No. 6,721,716 describes an electronic statement, bill presentment and payment system and method including a customer client software program and client database, and a biller server software program and server database connected over an electronic information network. Salveson, in U.S. Pat. No. 6,886,741, describes an all-purpose transaction system using a universal card. Amir Herzberg, in “Payments and Banking with Mobile Personal Devices” in Communications of the ACM, Volume 46, Number 5, pages 53-58, May 2003 discusses some of the challenges and opportunities involved in using mobile personal devices for making secure payments and authorizing banking transactions. Michael McDougall et al., in “A Model-Based Approach to Integrating Security Policies for Embedded Devices” in EMSOFT '04, pages 211-219, Sep. 27-29, 2004, Pisa, Italy describes how a framework based on a concise formal model lets a person securely customize a payment card equipped with a programmable chip. Ronald J. Mann, in “Regulating Internet Payment Intermediaries” in ICEC 2003, pages 376-386, Pittsburgh, Pa. examines legal and policy issues raised by changes in payment methods related to the rise of the Internet. Y. Yemini et al., in “MarketNet: Market-Based Protection of Information Systems” in ICE 98, pages 181-190, Charleston, S.C. describes novel market-based technologies for systematic, quantifiable and predictable protection of information systems against attacks. Ildemaro Araujo et al., in “Developing Trust in Internet Commerce”, School of Computer Science, Carleton University outlines essential issues that may affect customers' trust on Web sites or vendors.

In summary, the existing technical solutions do not show a system and method for processing payment options, including consolidation, selection, and secure identification, that overcomes some of the problems listed hereinabove.

### SUMMARY OF THE INVENTION

It is an object of the present invention to provide a system and method for processing payment options, including consolidation, selection, and secure identification (ID).

In one embodiment, multiple payment options such as credit cards, debit cards, loyalty cards, etc. are registered by a consumer and consolidated into a secure central repository. Once registered, the consumer no longer needs to physically carry all of the cards. Rather, the consumer may securely access the central repository over a secure communications channel from a remote access device, such as a point-of-sale (POS) terminal at a merchant store, to retrieve and select from one of the available payment methods for use.

In one case, the consumer uses a piece of identification and password, such as one of the registered cards together with a password or personal identification number (PIN), to securely access the multiple payment options. Alternatively, the consumer may identify himself using a biometric identifier, such as a fingerprint or retinal scan, without the need for a separate piece of ID.

In accordance with one aspect of the invention, there is provided a method of processing payment options, the steps comprising creating a user account for a user; receiving payment options data; and storing the payment options data into a central database, the central database being configured such that the stored payment options data is retrievable from a remote access device.

In accordance with another aspect of the invention, there is provided a system for processing payment options, comprising means for creating a user account for a user; means for receiving payment options data; and means for storing the payment options data into a central database, the central database being configured such that the stored payment options data is retrievable from a remote access device.

In accordance with yet another aspect of the invention, there is provided a data processor readable medium storing data processor code that when executed on a data processing device adapts the device to process payment options, comprising code for creating a user account for a user; code for receiving payment options data; and code for storing the payment options data into a central database, the central database being configured such that the stored payment options data is retrievable from a remote access device.

### BRIEF DESCRIPTION OF THE DRAWINGS

A complete understanding of the present invention may be obtained by reference to the accompanying drawings, when considered in conjunction with the subsequent detailed description, in which:

FIG. 1 shows a schematic block diagram that illustrates a generic data processing system that provides a suitable operating environment according to the present invention;

FIG. 2 shows a schematic block diagram of a system in accordance with one embodiment of the present invention; and

FIG. 3 shows a flowchart of a method for processing payment options in accordance with another embodiment of the present invention.

### DETAILED DESCRIPTION OF THE PREFERRED EMBODIMENTS

As noted above, the present invention relates to a system and method for processing payment options, including consolidation, selection, and secure identification.

The invention may be practiced in various embodiments. A suitably configured data processing system, and associated communications networks, devices, software and firmware provide a platform for enabling one or more of these systems and methods.

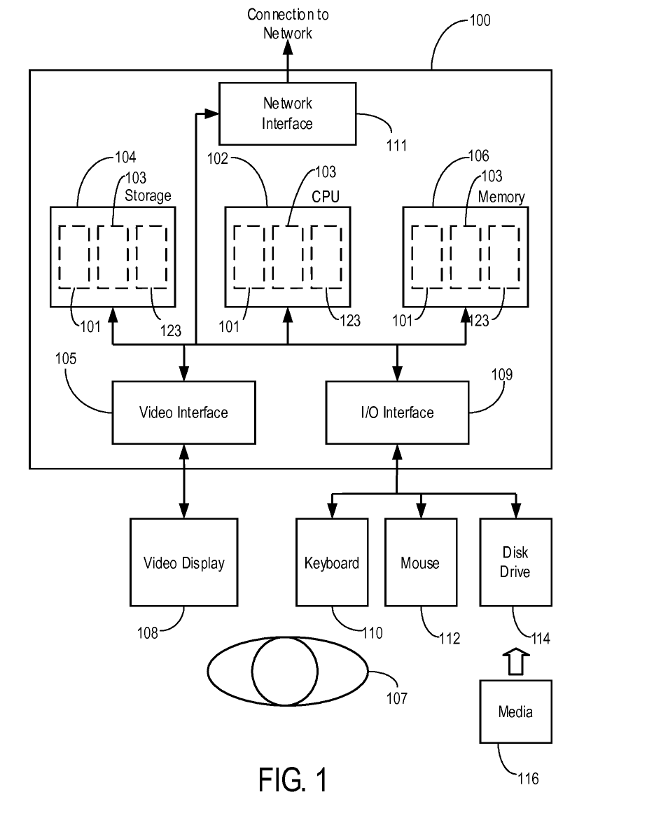

Referring first to FIG. 1, there is shown an example of a generic data processing system 100 that includes a central processing unit (CPU) 102 connected to a storage unit 104 and to random access memory 106. CPU 102 processes operating system 101, application program 103, and data 123. Operating system 101, application program 103, and data 123 are stored in storage unit 104 and loaded into memory 106, as required. An operator 107 interacts with data processing system 100 using a video display 108 connected by a video interface 105, and various input/output (I/O) devices such as a keyboard 110, mouse 112, and disk drive 114 connected by an I/O interface 109. In known manner, mouse 112 is configured to control movement of a cursor on video display 108 and to operate various graphical user interface (GUI) controls appearing on the video display with a mouse button. Disk drive 114 is configured to accept data processing system 100 readable media 116. Data processing system 100 forms part of a network via a network interface 111, allowing the data processing system to communicate with other suitably configured data processing systems (not shown). It should be understood by those skilled in the art that the invention is not considered limited to the particular configurations and examples chosen for purposes of the above described disclosure.

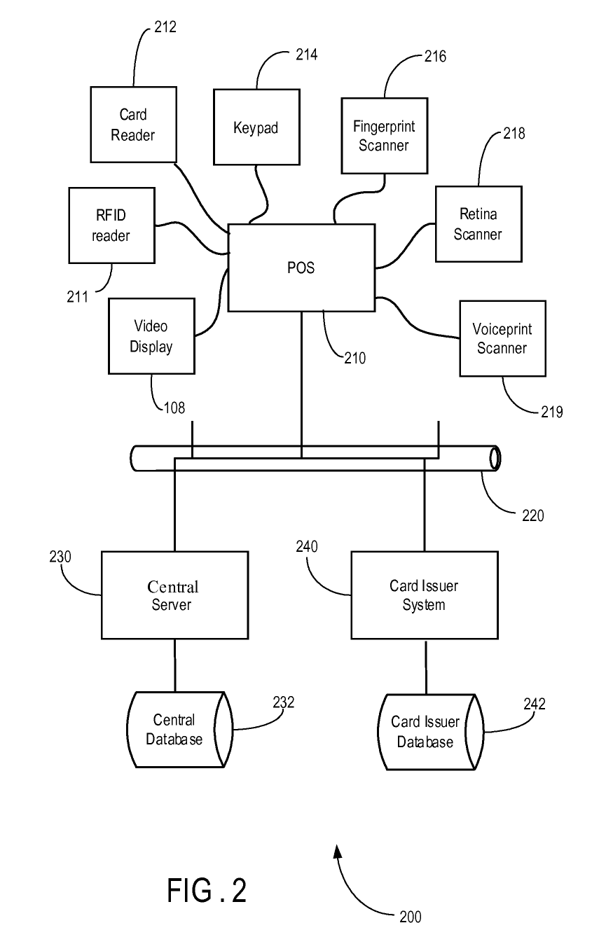

Referring now to FIG. 2, there is shown a schematic block diagram of a system 200 in accordance with another embodiment of the invention. In this embodiment, system 200 includes a POS terminal 210 that may be suitably adapted, for example, from various parts and components from generic data processing system 100 (see FIG. 1). POS terminal 210 is configured with various peripheral devices, such as a radio frequency ID (RFID) reader 211 to read an embedded RFID tag in a card, a card reader 212 to swipe a magnetic stripe on a card, and a keypad 214 to allow the consumer/user to enter a security PIN associated with the card. POS terminal 210 may also be configured with one or more biometric scanners, such as a fingerprint scanner 216, a retina scanner 218, or a voiceprint scanner 219, that may be used to uniquely identify a consumer. A biometric scan, a swiped or sensed card together with a PIN, or an account ID together with a password may be used for authorizing access to system 200 as will be explained hereinbelow.

Still referring to FIG. 2, in one example, POS terminal 210 is operatively connected to a central server 230 via a communication network 220 using a secure, encrypted communication channel. Communication network 220 may be a private network, or a public network such as the Internet on which a secure communication channel may be established.

Central server 230 may be configured with a central database 232 (e.g., as provided in storage unit 104 of data processing system 100 (see FIG. 1)), that may store various pieces of consumer related data and merchant related data. For consumers, central database 232 may be configured to consolidate and store information about various consumer specific payment methods available to each consumer. The information about various consumer specific payment methods may include the type of payment option (e.g., credit cards, debit cards, loyalty cards, etc.), and data relating to each type of payment option.

If authorized by the consumer, system 200 may perform an identification check or a credit check to ensure that a consumer has the right to use all of the registered payment cards. For example, this may be done automatically by confirming the identity of the consumer with each card issuing institution by accessing a card issuer system 240 with a card issuer database 242. Similarly, the consumer's credit may be checked with a credit bureau (not shown).

Once the identity of the consumer and all the data entered by the consumer is verified, the consumer may be registered with system 200, and may access his or her list of payment options from any suitably configured remote access device, such as POS terminal 210 at a participating merchant location.

In another embodiment, a consumer is required to complete a part of the registration process at one of the POS terminals 210. For example, the consumer may be required to use a photo ID card and PIN issued following online registration in order to activate the consumer's account on system 200.

Still referring to FIG. 2, there may be provided a video display 108 at each POS terminal 210 for displaying data, including the available list of payment options selectable by the consumer. As noted above, POS terminal 210 may be configured with various peripheral devices to identify the consumer to system 200. For example, card reader 212 may be used to swipe a consumer's photo ID card, and keypad 214 may be used to enter the PIN associated with the card. Alternatively, biometric scanners such as fingerprint scanner 216 or retina scanner 218 may also be used to positively identify a consumer before permitting access.

Video display 108 may display a list of payment options available for use by a consumer via system 200. For example, if the consumer has registered three major credit cards, all three cards may be displayed on video display 108 for selection as a payment option by the consumer. In order to limit consumer information provided to the merchant to only that which is necessary for the transaction, video display 108 may initially display only the type of payment option that the consumer may select, without any corresponding data such as individual card numbers.

Upon selection of one of the available payment options, card number data and any verification code corresponding to the selected payment option may be retrieved from central database 232, and provided to the merchant to complete the payment transaction. In terms of information provided, this is the equivalent of providing a merchant a credit card with a credit card number, and a three or four digit verification code that may also be printed on the credit card.

If the consumer has provided a fingerprint scan, retinal scan, or voiceprint scan that has been stored into system 200, once the identity of the consumer is verified through a verification process, the system may rely solely on the fingerprint, retinal scan, or voiceprint scan for identification of the consumer, eliminating the need for any other form of identification. Thus, every time a consumer visits a POS terminal 210, the consumer/user can provide a biometric scan in order to access the list of payment options previously registered by the consumer. The selected payment option is used to make payment for whatever goods or services the consumer is purchasing from the merchant (or service provider). The transaction may then be completed in a conventional manner, with the merchant performing any further processing as necessary with the additional data received for the selected payment option.

In one embodiment, the consumer can select a default payment option for a particular merchant, if allowed by that merchant. If no default option is provided by a particular merchant, the last payment method used with that merchant may be highlighted for selection, and the consumer can either agree to select the highlighted payment method, or disagree and select a different payment method. Alternatively, payment options not accepted by a merchant are unavailable for selection by the consumer. In either case, central server 230 on a back-end data processing system (not shown) is configured to recognize and identify which merchant's POS terminal 210 a consumer is accessing.

As an example, if a merchant accepts only two of three major credit cards registered by a consumer and stored in central database 232, the credit card that is not accepted by the merchant may not be available for selection on video display 108 at POS terminal 210 at the merchant location. For example, if video display 108 has a GUI display, a payment option not accepted by the merchant may be faded out so that it is not selectable. Alternatively, a payment option not accepted by the merchant may simply not be listed as an option.

In order to specifically identify a merchant location, each POS terminal 210 is provided with a specific identification number registered with and recognized by central server 230 as being used by a particular merchant. The peripheral devices provided with POS terminal 210 are configured to specifications, based on the merchant's preferences. However, in order to provide a consumer with the greatest flexibility for selecting a convenient payment option, POS terminal 210 may be configured with all of the various card readers 212, RFID readers 211, keypads 214, and scanners 216, 218 and 219 mentioned hereinabove. Each of these readers and scanners may be configured to establish a secure, encrypted connection with central server 230 for transmission of sensitive data and personal information. Each time a request is made for access, the identification number of POS terminal 210 is transmitted to central server 230 in order to verify the identity of the merchant.

In another embodiment, if consumer credit rating information is stored in or otherwise accessible to system 200, with the consumer's authorization, a merchant may create a profile for the type of payment option(s) available to a consumer with a particular credit rating. For example, a consumer with a high credit rating may be offered the use of any payment option. Alternatively, a consumer with a lower credit rating may be limited to a payment option such as a debit card. For specific identification of a consumer, a fingerprint scan, a retina scan, a voiceprint, or any registered card for that person together with a PIN may be accepted. Various combinations of these identification methods may also be used.

In another embodiment, POS terminal 210 may be used to display information such as a targeted advertising campaign on display 108 targeted to the consumer or user identified as accessing the central database 232. For example, the advertising may be run by credit card providers offering a special low interest rate or a longer interest free period. Other features offered might be instant sign up, secure identification, and real-time credit history check for a consumer that signs up for a card at POS terminal 210.

Various charges may be applied for the use of system 200, such as POS terminal 210 transaction charges, percentage of payment charges, flat usage charges based on number of times a consumer accesses the system, etc. Virtually any type of service or convenience charge may be imposed, and could be charged to the consumer using the same payment method selected by the consumer for the main transaction.

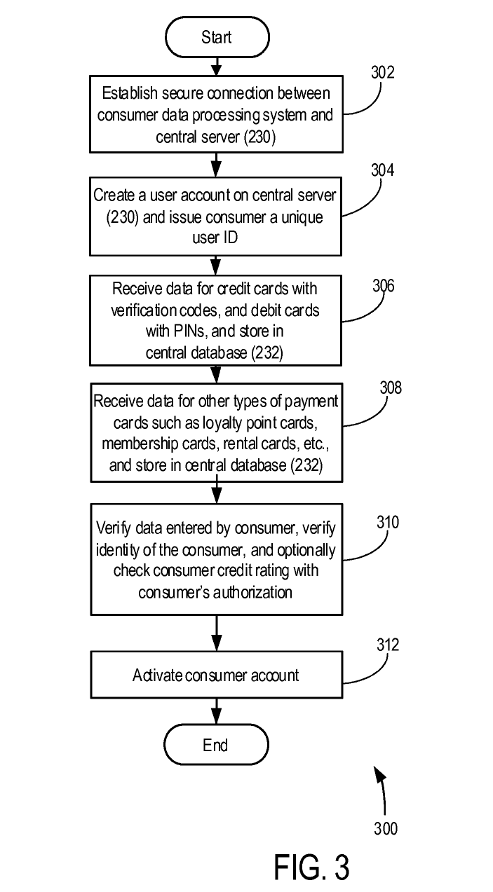

Referring now to FIG. 3, which references elements of FIG. 2, there is shown a flowchart of an illustrative registration process 300 that a consumer may use in order to register various types of payment options with system 200. Beginning at step 302, a secure connection is created (e.g., via a secure web browser) between consumer data processing system 100 (see FIG. 1) and central server 230. Next in step 304, a user account or consumer account is created for a consumer/user on central server 230. In some embodiments, the consumer may be required to enter a PIN, and if so, receives a unique user ID associated with the consumer account. In step 306, process 300 receives the payment option information from the consumer. For example, the consumer may provide credit card information, one card at a time, which is received and stored into central database 232. In one embodiment, the consumer selects the type of credit card, enter a credit card number, the expiration date of the card, a three or four digit security code, and his or her name as it appears on the card, all of which is received and stored in central database 232. If a debit card is chosen to be entered, the consumer typically is required to select a banking institution, enter a debit card number, and an associated PIN for security, all of which is received for storage into database 232.

Next, at step 308, process 300 receives data from the consumer for other types of cards that may be accepted for payment by various merchants, such as loyalty point cards, membership cards, rental cards, etc. In each case, the consumer selects the payment option type, and enters any associated PIN or security number, if required to use a particular card.

Then in step 310, process 300 verifies all of the data entered by a consumer, the consumer's identity, and the consumer's credit rating as authorized by the consumer. Process 300 then proceeds to step 312 and activates the consumer's account on system 200, which completes the process.

The activation process at step 312 may be completed in a number of ways. In one embodiment, if a consumer has previously entered all of the data online, the consumer will have had to register at least one payment card, and will have created a PIN. In this case, the consumer may simply swipe any one of the cards previously registered with system 200 and stored in central database 232, and enter an associated PIN. Alternatively, the consumer may also be required to show photo identification, or to provide a biometric scan (such as a retinal or fingerprint scan) to complete the registration process.

In another embodiment, if a consumer has not previously registered online, one option that is available to the consumer is to fully complete registration at one of the POS terminals 210, or a suitably configured terminal (not shown) provided at a dedicated registration site. In this case, the consumer may be required to provide photo identification, and then to create a new account on system 200 from POS terminal 210. Again, the consumer is given an account number, and an opportunity to create a PIN. The consumer may proceed to swipe each card, one at a time, using card reader 212 rather than being required to enter the data manually. After each swipe, the consumer needs to manually enter any required information, such as a three or four digit verification code, or a PIN associated with a debit card.

Once entry of data is completed for the various cards, the consumer may also provide a biometric scan (e.g., a retinal or fingerprint scan) for input into the central database 232, for reference and comparison to a subsequent scan. Again, a consumer identification and data verification process is used to validate all of the cards registered by the user.

Once registration of data and verification is complete, the consumer's account may be activated and the consumer may be allowed to access the system 200, and the consumer may then use any of the cards registered into the system.

Although the system and method for processing payment options of the instant invention have been described in detail in conjunction with the above embodiments, since other modifications and changes varied to fit particular requirements and environments will be apparent to those skilled in the art, the invention is not considered limited to examples chosen for purposes of the above described disclosure, and covers all changes and modifications which do not constitute departures from the true spirit and scope of this invention as defined by the appended claims.

What is claimed is:

1. A method of processing payment options, the steps comprising:
a) creating a user account for a user;
b) receiving payment options data; and
c) storing said payment options data into a central database, said central database being configured such that said stored payment options data is retrievable from a remote access device.

2. The method as recited in claim 1, wherein said receiving step (b) comprises receiving said payment options data from said user for each type of payment card, including a card number and an associated verification code; and wherein said storing step (c) comprises storing said card number and an associated verification code into said central database.

3. The method as recited in claim 2, the steps further comprising:
d) receiving a request from said remote access device to access said central database;
e) verifying the identity of said user attempting to access said central database; and
f) displaying on said remote access device a list of available payment options selectable by said user from said remote access device.

4. The method as recited in claim 3, the steps further comprising:
g) receiving a selection of one from said list of available payment options selectable by said user; and
h) providing additional payment options data to said remote access device sufficient to process a payment from said remote access device.

5. The method as recited in claim 4, the steps further comprising:
i) prior to said verifying step (e), obtaining said user's biometric data and storing said user's biometric data into said central database; and
wherein said verifying step (e) comprises verifying said identity of said user using at least one of: data relating to one of said stored payment options data from said user for each type of payment card, including a card number and an associated verification code; and data relating to a comparison of said user's biometric data scanned at said remote access device to said stored biometric data.

6. The method as recited in claim 4, the steps further comprising:
i) identifying said remote access device; and
j) modifying said list of available payment options dependent upon said identity of said remote access device.

7. The method as recited in claim 6, the steps further comprising:
k) displaying at said remote access device information targeted to said identified user accessing said central database.

8. A system for processing payment options, comprising:
a) means for creating a user account for a user;
b) means for receiving payment options data; and
c) means for storing said payment options data into a central database, said central database being configured such that said stored payment options data is retrievable from a remote access device.

9. The system as recited in claim 8, further comprising means for receiving said payment options data from said user for each type of payment card, including a card number and an associated verification code; and means for storing said card number and an associated verification code into said central database.

10. The system as recited in claim 9, further comprising means for receiving a request from said remote access device to access said central database; means for verifying said identity of said user attempting to access said central database; and means for displaying on said remote access device a list of available payment options selectable by said user from said remote access device.

11. The system as recited in claim 10, further comprising means for receiving a selection of one from said list of available payment options selectable by said user; and means for providing additional payment options data to said remote access device sufficient to process a payment from said remote access device.

12. The system as recited in claim 11, further comprising means for obtaining said user's biometric data and storing said user's biometric data into said central database; and means for verifying said identity of said user using at least one of: data relating to one of said stored payment options data from said user for each type of payment card, including a card number and an associated verification code; and data relating to a comparison of said user's biometric data scanned at said remote access device to said stored biometric data.

13. The system as recited in claim 11, further comprising means for identifying said remote access device; and means for modifying said list of available payment options dependent upon said identity of said remote access device.

14. The method as recited in claim 13, further comprising means for displaying at said remote access device information targeted to said identified user accessing said central database.

15. A data processor readable medium storing data processor code that when executed on a data processing device adapts the device to process payment options, comprising:
a) code for creating a user account for a user;
b) code for receiving payment options data; and
c) code for storing said payment options data into a central database, said central database being configured such that said stored payment options data is retrievable from a remote access device.

16. The data processor readable medium as recited in claim 15, further comprising code for receiving said payment options data from said user for each type of payment card, including a card number and an associated verification code; and code for storing said card number and an associated verification code into said central database.

17. The data processor readable medium as recited in claim 16, further comprising code for receiving a request from said remote access device to access said central database; code for verifying said identity of said user attempting to access said central database; and code for displaying on said remote access device a list of available payment options selectable by said user from said remote access device.

18. The data processor readable medium as recited in claim 17, further comprising code for receiving a selection of one from said list of available payment options selectable by said user; and code for providing additional payment options data to said remote access device sufficient to process a payment from said remote access device.

19. The data processor readable medium as recited in claim 18, further comprising code for obtaining said user's biometric data and storing said user's biometric data into said central database; and code for verifying said identity of said user using at least one of: data relating to one of said stored payment options data from said user for each type of payment card, including a card number and an associated verification code; and data relating to a comparison of said user's biometric data scanned at said remote access device to said stored biometric data.

20. The data processor readable medium as recited in claim 18, further comprising code for identifying said remote access device; and code for modifying said list of available payment options dependent upon the identity of said remote access device.

21. The data processor readable medium as recited in claim 20, further comprising code for displaying at said remote access device information targeted to said identified user accessing said central database.
